(19) United States
(12) Patent Application Publication
(10) Pub. No.: US 2017/0257165 A1
(43) Pub. Date: Sep. 7, 2017

(54) SIGNAL PROCESSING APPARATUS

(71) Applicant: BAE Systems plc, London (GB)

(72) Inventors: Christopher Ralph Pescod, Chelmsford, Essex (GB); Mohammed Nawaz, Chelmsford, Essex (GB); Colin James Harper, Chelmsford, Essex (GB)

(21) Appl. No.: 15/508,696

(22) PCT Filed: Sep. 2, 2015
(86) PCT No.: PCT/GB2015/052527

§ 371 Date: Mar. 3, 2017

(30) Foreign Application Priority Data
Sep. 12, 2014 (GB) 1416110.3

(51) Int. Cl. H04B 10/2575; B64F 5/60

(52) U.S. Cl. CPC H04B 10/2575; B64F 5/60

(57) ABSTRACT

Signal processing apparatus located in and/or mounted on an entity (e.g. an aircraft), the signal processing apparatus comprising: a first module; a second module connected to the first module such that signals may be sent between those modules; one or more amplifiers configured to amplify signals sent between the modules; and one or more optical fibres. The first module is located at a first location in/on the entity. The second module and the one or more amplifiers are located at a second location in/on the entity. The first location and the second location are spatially separate, i.e. remote from one another. The optical fibre(s) couple together the first and the second locations such that a signal sent between those locations is sent via the optical fibre(s).

### FIELD OF THE INVENTION

The present invention relates to signal processing apparatus and in particular signal processing apparatus that is mounted wholly on and/or in an entity, for example, a vehicle.

### BACKGROUND

Many aircraft, including unmanned aircraft, utilise a number of communication and data link systems to enable them to operate effectively.

Typically, these systems include one or more signal transceivers connected to one or more antennas.

The transceivers tend to be located within in a fuselage of the aircraft, for example, in a central equipment bay.

Also, the antennas of the aircraft tend to be located at or proximate to extremities of the aircraft, for example, at or proximate to the aircraft wing tips. This tends to reduce or eliminate signal blocking by the body of the aircraft.

The transceivers are usually connected to the antennas via electrical conductive cables such as coaxial cable. Such coaxial cable tends to be heavy. Also, signals carried by such coaxial cable tend to experience loss (i.e. the coaxial cable tends to be “lossy”). For example, a 10 dB loss in signal strength per 5 m to 10 m of coaxial cable may be experienced.

To mitigate this signal loss, high power amplifiers may be used. Such amplifiers may be located within the equipment bay. These amplifiers tend to be heavy.

Quite separate from the field of aircraft communications, it is known to intensity modulate an optical carrier signal with an electrical signal. For example, it is known to use optical modulators (e.g. Mach-Zehnder modulators) to modulate an input optical carrier with a radio frequency (RF) communications signal.

### SUMMARY OF THE INVENTION

The present inventors have realised that the low level transmit signal generation and receive signal processing functions of a communications system on an aircraft may be separated from the transmit high power amplifier and receive low noise amplifier on an aircraft.

The present inventors have further realised that, by separating the low level transmit signal generation and receive signal processing functions from the transmit high power amplifier and receive low noise amplifier, the transmit high power amplifier and/or receive low noise amplifier may be located close to an antenna on the wing or fuselage of the aircraft.

The present inventors have further realised that by locating the transmit high power amplifier and/or receive low noise amplifier close to an antenna, lower power, lighter amplifiers may be implemented. Thus, surprisingly, a space and weight saving may be achieved by separating the low level transmit signal generation and receive signal processing functions from the transmit high power amplifier and receive low noise amplifier.

Conventionally, space and weight reduction tend to result from integrating apparatus together so as to have fewer modules. However, the present inventors have realised that a space and weight reduction may be achieved by surprisingly doing the opposite of this, namely, separating the low level transmit signal generation and receive signal processing functions from the transmit high power amplifier and receive low noise amplifier.

The present inventors have further realised that the use of wideband optical fibre links tends to facilitate the separation of the low level transmit signal generation and receive signal processing functions from the transmit high power amplifier and receive low noise amplifier.

The present inventors have further realised that signal losses between the low level transmit signal generation and receive signal processing functions (which may be centrally located on an aircraft, e.g., in an equipment bay) and the transmit and receive amplifiers (which may be located proximate to an antenna, remote from the low level transmit signal generation and receive signal processing functions) may be reduced by using an optical communication link to relay signals between those units.

The present inventors have further realised that a lower power high power amplifier can be used given that the interconnection loss between the high power amplifier and antenna are significantly reduced as the two are in relatively close proximity.

The present inventors have further realised that a substantial weight saving may be achieved by connecting the low level transmit signal generation and receive signal processing functions to the transmit and receive amplifiers using an optical fibre communication link to relay signals, as opposed to an electrically conductive cable as is used conventionally.

In a first aspect, the present invention provides signal processing apparatus located in and/or mounted on an entity, the signal processing apparatus comprising: a first module; a second module operatively connected to the first module such that a signal may be sent between the first module and the second module; one or more amplifiers operatively connected to the first and second modules such that a signal sent between the first module and the second module is amplified by the one or more amplifiers; and one or more optical fibre communication links. The first module is located at a first location in or on the entity. The second module and the one or more amplifiers are located at a second location in or on the entity. The first location and the second location are spatially separate such that the first module is remote from the second module and the one or more amplifiers. The one or more optical fibre communications links couple together the first location and the second location such that a signal sent between the first location and the second location is sent via the one or more optical fibre communications links.

The signal may be a radio frequency (RF) signal.

The first module may comprise a signal processor configured to output a signal for use by the second module. The apparatus may further comprise a first optical modulator located at the first location and operatively coupled to the signal processor and configured to produce a modulated optical signal corresponding to the signal output by the signal processor. The first optical modulator may be further operatively coupled to the one or more optical communication links such that the modulated optical signal produced by the first optical modulator is sent to the second location via the one or more optical communication links.

The apparatus may further comprise a first optical-electrical converter located at the second location and configured to convert the optical signal received from the first location to an electrical signal. The second module may comprise an antenna configured to transmit, for use by a further entity remote from the entity, the electrical signal produced by the first optical-electrical converter.

The one or more amplifiers may include a power amplifier configured to amplify the electrical signal output by the first optical-electrical converter and provide the amplified signal to the antenna.

The second module may comprise an antenna configured to receive, from a further entity remote from the entity, a signal. The apparatus may further comprise a second optical modulator located at the second location and operatively coupled to the signal processor and configured to produce a modulated optical signal corresponding to the signal received by the antenna. The second optical modulator may be further operatively coupled to the one or more optical communication links such that the modulated optical signal produced by the second optical modulator is sent to the first location via the one or more optical communication links.

The apparatus may further comprise a second optical-electrical converter located at the first location and configured to convert the optical signal received from the second location to an electrical signal. The first module may comprise a signal processor configured to process the electrical signal output by the second optical-electrical converter.

The one or more amplifiers may include a low noise amplifier configured to amplify the signal received by the antenna and provide the amplified signal to the second optical modulator.

The apparatus may further comprise a laser. The laser may be operatively coupled to the second optical modulator via a polarisation maintaining optical fibre communications link. The laser may be configured to produce an optical input to the second optical modulator for modulation by the second optical modulator. The laser may be located at the first location.

The apparatus may further comprise: a further first module; a further second module operatively connected to the further first module such that a signal may be sent between the further first module and the further second module; one or more further amplifiers operatively connected to the further first and further second modules such that a signal sent between the further first module and the further second module is amplified by the one or more amplifiers; and a multiplexer configured to multiplex the signal being sent between the first module and the second module and the signal being sent between the further first module and the further second module onto a common optical fibre communication link.

The apparatus may further comprise a de-multiplexer configured to de-multiplex the multiplexed signal produced by the multiplexer into the signal being sent between the first module and the second module and the signal being sent between the further first module and the further second module. The multiplexer and the de-multiplexer may be located at different respective locations selected from the group of locations consisting of the first location and the second location.

The apparatus may further comprise: at least one further second module operatively connected to the first module such that a signal may be sent between the first module and each of the further second modules; an optical modulator located at the first location and operatively coupled to the signal processor and configured to modulate an optical input so as to produce a modulated optical signal corresponding to a signal output by the first module; a controller configured to select a wavelength from a set of multiple different wavelengths for the optical input to the optical modulator; one or more lasers configured to produce the optical input to the optical modulator having the selected wavelength; and means for directing optical signals having different wavelengths to a different respective second module.

The apparatus may further comprise: at least one further second module operatively connected to the first module such that a signal may be sent between the first module and each of the further second modules; for each second module, a respective optical modulator operatively coupled to that second module and configured to produce a modulated optical signal, the optical modulators being configured to each produce a modulated optical signal having a different respective wavelength; and, for at least one of the wavelengths of the signals produced by the optical modulators, a filter for preventing a signal having that wavelength being received by the first module.

The entity may be an aircraft, for example, an unmanned aircraft.

The second location may be in or on a wing of the aircraft. The first location may be remote from a wing of the aircraft, for example, in an equipment bay located in a central portion of the aircraft.

In a further aspect, the present invention provides an aircraft comprising signal processing apparatus according to the first aspect.

### BRIEF DESCRIPTION OF THE DRAWINGS

FIG. 1 is a schematic illustration (not to scale) of a first embodiment of a signal transmitting/receiving system;

FIG. 2 is a schematic illustration (not to scale) of a first optical-electrical conversion module;

FIG. 3 is a schematic illustration (not to scale) of a second optical-electrical conversion module;

FIG. 4 is a schematic illustration (not to scale) of an unmanned aircraft upon which the system is implemented;

FIG. 5 is a schematic illustration (not to scale) of a second embodiment of a signal transmitting/receiving system;

FIG. 6 is a schematic illustration (not to scale) of a part of a signal transmitting/receiving system according to a third embodiment;

FIG. 7 is a schematic illustration (not to scale) of a further part of a signal transmitting/receiving system according to a third embodiment;

FIG. 8 is a schematic illustration (not to scale) of an optical wavelength selectable optical-electrical conversion module; and

FIG. 9 is a schematic illustration (not to scale) showing an optical-electrical conversion module having a remotely located laser.

### DETAILED DESCRIPTION

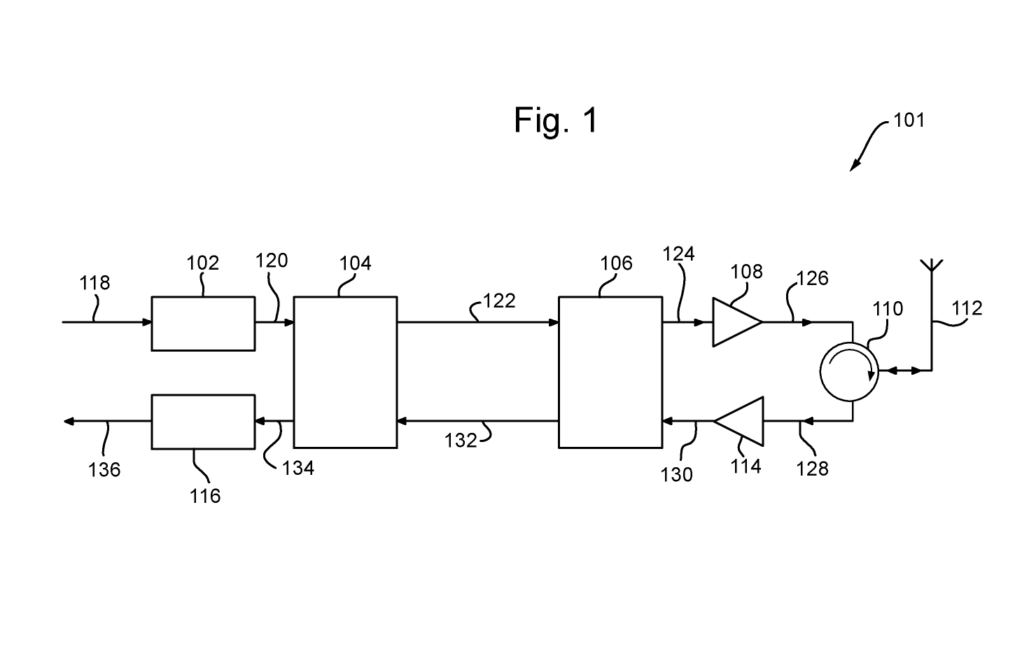

FIG. 1 is a schematic illustration (not to scale) of a first embodiment of a signal transmitting/receiving system 101. In this embodiment, the system 101 is implemented on-board (i.e. located within and/or mounted on) an aircraft, as described in more detail later below.

The system 101 comprises a transmit signal processing module 102, a first optical-electrical conversion module 104 (hereinafter referred to as the “first optical module”), a second optical-electrical conversion module 106 (hereinafter referred to as the “second optical module”), a power amplifier 108, an electrical circulator 110, an antenna 112, a low-noise amplifier 114, and a receive signal processing module 116.

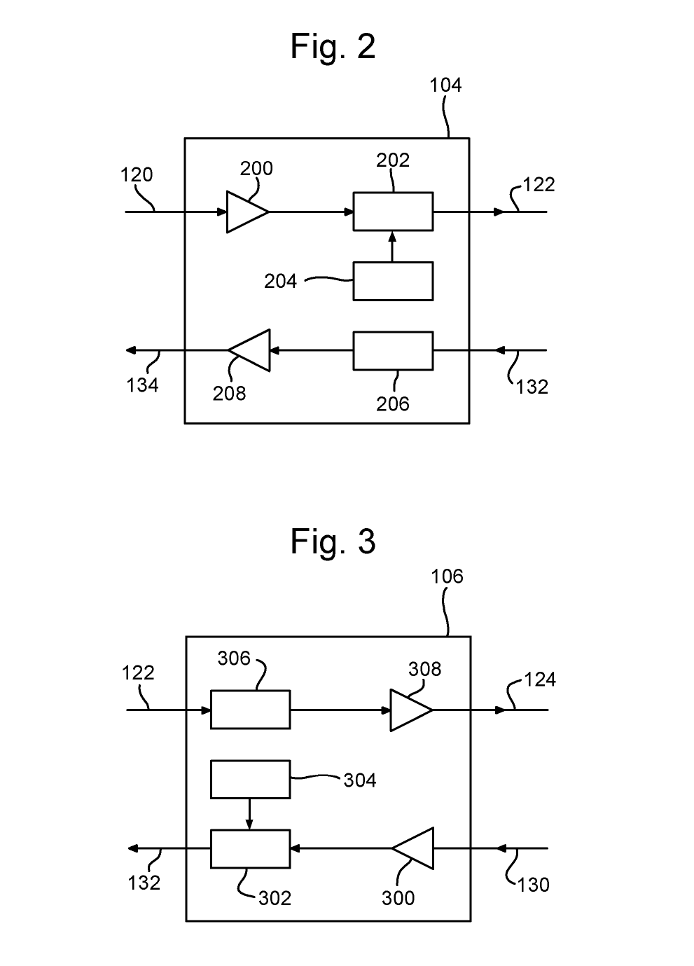

What will now be described is an example operation of transmitting and receiving signals by the system 101. The couplings and connections between the modules and elements of the system 101 will also be described. In the below description, reference is made to FIG. 2, which shows further details of the first optical module 104, and FIG. 3, which shows further details of the second optical module 106.

In an example signal transmission operation, a digital or analogue base-band signal to be transmitted is input via a first electrical link 118 to the transmit signal processing module 102. The transmit signal processing module 102 processes the received base-band signal and outputs a radio-frequency (RF) signal for transmission.

The transmit signal processing module 102 is electrically coupled to the first optical module 104 via a second electrical link 120 such that, in operation, the RF signal output by the transmit signal processing module 102 is sent from the transmit signal processing module 102 to the first optical module 104.

The first optical module 104 is illustrated schematically (not to scale) in FIG. 2. In this first embodiment, the first optical module 104 comprises a first RF amplifier 200, a first optical modulator 202, a first laser 204, a first photodiode detector 206, and a first module low noise amplifier 208.

In the example transmission operation, the first RF amplifier 200 receives and amplifies the RF signal output by the transmit signal processing module 102. The amplified RF signal is then sent from the first RF amplifier 200 to the first optical modulator 202.

In this embodiment, the first optical modulator 202 is an integrated optical Mach Zehnder modulator. However, in other embodiments a different type of optical modulator may be used. The first optical modulator 202 is coupled to the first laser 204 using a polarisation maintaining (PM) fibre. The first laser 204 is a laser diode optical source that is biased at a constant output level. In this embodiment, the output from the first laser 204 is coupled using polarisation maintaining optical fibre to the input of the first optical modulator 202. In operation, the amplified RF signal received by the first optical modulator 202 from the first RF amplifier 200 is applied to an RF electrode of the first optical modulator 202, thereby generating an electric field which is applied across two optical waveguides of the first optical modulator 202. Under action of the applied electric field, the refractive indices of the optical waveguides of the first optical modulator 202 are changed (i.e. increased/decreased) relative to one another, thus causing interference (e.g. constructive or destructive interference) at an output coupler of the first optical modulator 202. Thus, an intensity modulated optical signal is produced. In other words, the constant optical output of the first laser 204 is modulated by the first optical modulator 202 using the amplified RF signal so as to produce an intensity modulated optical signal. The modulated optical signal produced by the first optical modulator 202 is sent, via a first optical fibre 122, to the second optical module 106.

In this embodiment, the first optical fibre 122 is a single mode optical fibre. However, this need not be the case, and in other embodiments other types of optical fibre may be used instead.

In the example transmission operation, the modulated optical signal is received by the second optical module 106 via the first optical fibre 122. The second optical module 106 is illustrated schematically (not to scale) in FIG. 3. In this first embodiment, the second optical module 106 comprises a second RF amplifier 300, a second optical modulator 302, a second laser 304, a second photodiode detector 306, and a second module low noise amplifier 308.

In this embodiment, the second photodiode detector 306 receives and demodulates the modulated optical signal received via the first optical fibre 122, thereby producing a corresponding RF electrical signal, which may be substantially the same as the RF signal to be transmitted. The RF signal output by the second photodiode detector 306 is then sent to the second module low noise amplifier 308, which amplifies the RF signal. The amplified RF signal output by the second module low noise amplifier 308 is then sent, from the second module low noise amplifier 308, to the power amplifier 108 via a third electrical link 124.

In the example transmission operation, the power amplifier 108 amplifies the RF electrical signal received from the second optical module 106, and outputs an amplified RF signal. The power amplifier 108 sends the output amplified RF signal to the electrical circulator 110 via a fourth electrical link 126. The electrical circulator 110 directs the RF signal received from the power amplifier 108 to the antenna 112. The antenna 112 then transmits the RF signal received from the electrical circulator 110. Thus, an example process of transmitting a digital or analogue base-band RF signal by the system 101 is provided.

A free space link may be established between two spatially separated aircraft where each are equipped with a signal transmitting and receiving system 101.

In an example signal receiving operation, an RF receive signal is received by the antenna 112. An electrical signal corresponding to the RF signal received by the antenna 112 is sent from the antenna 112 to the electrical circulator 110. The electrical circulator 110 directs the RF signal received from the antenna 112 to the low-noise amplifier 114 via a fifth electrical link 128.

In the example signal receiving operation, the low-noise amplifier 114 amplifies the RF electrical signal received from the electrical circulator 110, and outputs an amplified RF signal. The low-noise amplifier 114 sends the output amplified RF signal to the second optical module 106 via a sixth electrical link 130.

In the example signal receiving operation, the second RF amplifier 300 of the second optical module 106 receives and amplifies the RF signal output by the low-noise amplifier 114. The amplified RF signal is then sent from the second RF amplifier 300 to the second optical modulator 302.

In this embodiment, the second optical modulator 302 is an integrated optical Mach Zehnder modulator. However, in other embodiments a different type of optical modulator may be used. The second optical modulator 302 may be substantially the same type of modulator as the first optical modulator 202. The second optical modulator 302 is coupled to the second laser 304 using a polarisation maintaining fibre. The second laser 304 is a laser diode optical source that is biased at a constant output level. The second laser 304 may be substantially the same type of laser as the first laser 204, for example, in some embodiments, the wavelength of the light produced by the first laser 204 may be the same as that produced by the second laser 304. In this embodiment, the output from the second laser 304 is coupled using polarisation maintaining optical fibre to the input of the second optical modulator 302. In operation, the amplified RF signal received by the second optical modulator 302 from the second RF amplifier 300 is applied to an RF electrode of the second optical modulator 302, thereby generating an electric field which is applied across two optical waveguides of the second optical modulator 302. Under action of the applied electric field, the refractive indices of the optical waveguides of the second optical modulator 302 are changed (i.e. increased/decreased) relative to one another, thus causing interference (e.g. constructive or destructive interference) at an output coupler of the second optical modulator 302. Thus, an intensity modulated optical signal is produced. In other words, the output of the second laser 304 is modulated by the second optical modulator 302 using the received amplified RF signal so as to produce a modulated optical signal. The modulated optical signal produced by the second optical modulator 302 is sent, via a second optical fibre 132, to the first optical module 104.

In this embodiment, the second optical fibre 132 is a single mode optical fibre. However, this need not be the case, and in other embodiments other types of optical fibre may be used instead.

In the example signal receiving operation, the modulated optical signal sent by the second optical modulator via the second optical fibre 132 is received by the first photodiode detector 206 of the first optical module 104. The first photodiode detector 206 demodulates the received intensity modulated optical signal, thereby producing a corresponding RF electrical signal, which may be substantially the same as the RF signal received at the antenna 112. The RF signal output by the first photodiode detector 206 is then sent to the first module low noise amplifier 208, which amplifies that RF signal. The amplified RF signal output by the first module low noise amplifier 208 is then sent, from the first module low noise amplifier 208, to the receive signal processing module 116 via a seventh electrical link 134.

The receive signal processing module 116 then processes the RF electrical signal received from the first optical module 104 and outputs, via an eighth electrical link 136, an electrical signal. Thus, an example process of receiving an RF signal by the system 101 is provided.

In this embodiment, the system 101 is implemented on-board an aircraft.

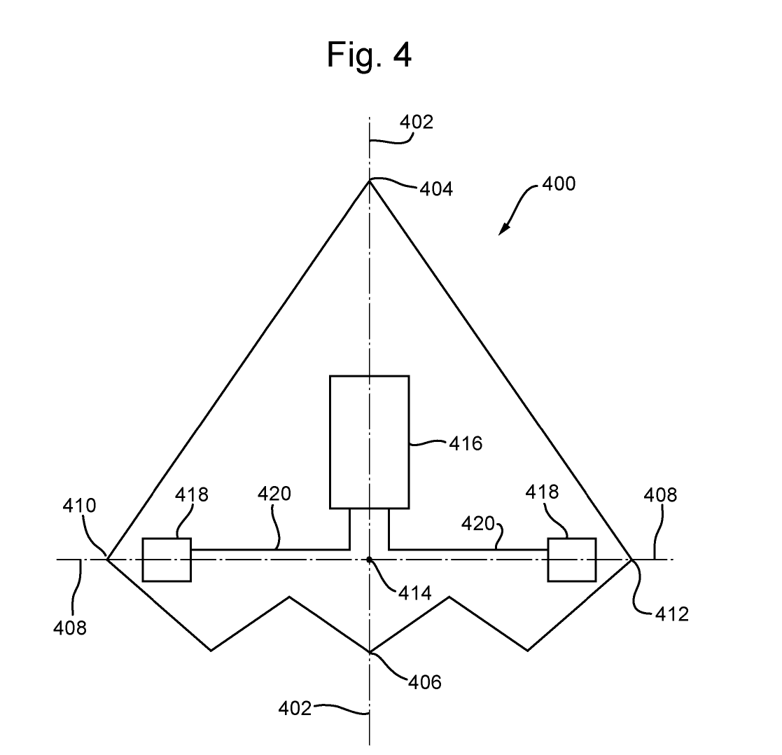

FIG. 4 is a schematic illustration (not to scale) of a plan view of an aircraft 400 in which, in this embodiment, the system 101 is implemented.

A roll axis, or longitudinal axis, of the aircraft 400 is illustrated in FIG. 4 by a dotted line and the reference numeral 402. The roll axis 402 passes through the body of the aircraft 400, from a nose 404 of the aircraft 400 to a tail 406 of the aircraft 400.

A pitch axis, or transverse axis, of the aircraft 400 is illustrated in FIG. 4 by a dotted line and the reference numeral 408. The pitch axis 408 passes through the body of the aircraft 400, from a tip of the left-hand wing 410 of the aircraft 400 to a tip of a right-hand wing 412 of the aircraft 400. The terminology “left-hand” and “right-hand” is used herein for ease of reference only and it will be appreciated that such terminology is merely used for identification purposes.

A yaw axis of the aircraft 400 is indicated in FIG. 4 by the reference numeral 414. The yaw axis 414 pass through the body of the aircraft 400 from the top of the aircraft 400 to the bottom of the aircraft 400 (i.e. perpendicular to the plane of the page upon which FIG. 4 is shown).

In this embodiment, the roll axis 402, the pitch axis 408, and the yaw axis 414 are mutually orthogonal.

The aircraft 400 comprises an equipment bay 416, and a plurality of wing bays 418.

The equipment bay 416 is a facility within the aircraft 400 in which equipment, such as signal processing apparatus and the like, may be housed. In this embodiment, the equipment bay 416 is located within a central portion of the aircraft 400. The roll axis 402 passes through the equipment bay 416. The equipment bay 416 is positioned along the roll axis 402. The equipment bay 416 may be substantially equidistant from the aircraft's wing tips 410, 412.

Each of the wing bays 418 is a facility within the aircraft 400 in which equipment may be housed. In this embodiment, each wing bay 418 is located proximate to a respective aircraft wing tip 410, 412. The wing bays 418 are aligned along the pitch axis 408. The wing bays 418 are spatially separated, i.e. remote from, the roll axis 402 of the aircraft 400. The wing bays 418 are spatially separated, i.e. remote from, the equipment bay 416 at least in a direction that points along the pitch axis 408 of the aircraft 400. The wing bays 418 may be substantially equidistant from the equipment bay 416. The wing bays 418 may be substantially equidistant from the roll axis 402.

In this embodiment, the equipment bay 416 is coupled to the wing bays 418 via communication links 420 such that signals may be sent from the equipment bay 416 to each of the wing bays 418 and vice versa.

In this embodiment, to provide “all-round” or spherical transmit/receive capability, the aircraft 400 comprises four systems 101 of the type shown in FIGS. 1-3 and described in more detail above. Thus, four antennas 112 are provided which are positioned on the aircraft as follows: an upper left-hand wing antenna positioned at or proximate to an upper surface of the aircraft 400 proximate to the left-hand wing tip 410; and a lower left-hand wing antenna positioned at or proximate to a lower surface of the aircraft 400 proximate to the left-hand wing tip 410; an upper right-hand wing antenna positioned at or proximate to an upper surface of the aircraft 400 proximate to the right-hand wing tip 412; and a lower right-hand wing antenna positioned at or proximate to a lower surface of the aircraft 400 proximate to the right-hand wing tip 412.

In this embodiment, the modules of each of the four systems 101 are distributed within the aircraft 400 as follows.

For each system 101, the transmit signal processing module 102, the first optical module 104, and the receive signal processing module 116 of that system 101 are wholly located within the equipment bay 416. The transmit signal processing module 102, the first optical module 104, and the receive signal processing module 116 of a system 101 are located proximate to one another such that the physical lengths of the electrical links 120, 134 which connect those modules (which may be, for example, electrically conductive coaxial cable) are relatively short, for example, compared to the optical connections 122, 132 that link together the optical modules 104, 106. Thus, the weight and signal losses resulting from those electrical connections tend to be reduced.

Also, for each system 101, the second optical module 106, the power amplifier 108, the electrical circulator 110, the antenna 112, and the low-noise amplifier 114 of that system 101 are wholly located in a common wing bay 418. The wing bay 418 in which the second optical module 106, the power amplifier 108, the electrical circulator 110, the antenna 112, and the low-noise amplifier 114 of a system 101 are located is the wing bay 418 that is at or proximate to the location of that antenna 112 on the aircraft 400. For example, for a system 101 corresponding to the upper left-hand wing antenna, the second optical module 106, the power amplifier 108, the electrical circulator 110, the (upper left-hand wing) antenna 112, and the low-noise amplifier 114 of that system 101 are wholly located in a wing bay 418 within the left-hand wing of the aircraft 400 proximate to the left-hand wing tip 410 and the upper surface of the aircraft 400. Similarly, for a system 101 corresponding to the lower right-hand wing antenna, the second optical module 106, the power amplifier 108, the electrical circulator 110, the (lower right-hand wing) antenna 112, and the low-noise amplifier 114 of that system 101 are wholly located in a wing bay 418 within the right-hand wing of the aircraft 400 proximate to the right-hand wing tip 412 and the lower surface of the aircraft 400.

The second optical module 106, the power amplifier 108, the electrical circulator 110, the antenna 112, and the low-noise amplifier 114 of a system 101 are located proximate to one another such that the physical lengths of the electrical links 124, 126, 128, 130 which connect those modules (which may be, for example, electrically conductive coaxial cable) are relatively short, for example, compared to the optical connections 122, 132 that link together the optical modules 104, 106. Thus, the weight and signal losses resulting from those electrical connections tend to be reduced.

In this embodiment, for each system 101, the transmit signal processing module 102, the first optical module 104, and the receive signal processing module 116 are spatially separated, i.e. remote from, the second optical module 106, the power amplifier 108, the electrical circulator 110, the antenna 112, and the low-noise amplifier 114.

In this embodiment, for each system 101, the modules of that system 101 that are located within the equipment bay 416 are coupled to the modules of that system 101 that are located within a common wing bay 418 via a communication link 420. Thus, in this embodiment, each communication link 420 corresponds to the first and second optical fibres 122, 132.

Thus, in this embodiment, modules that are physically separated by relatively large distances are coupled together by optical fibre communications links. This tends to be in contrast to conventional systems in which electrical signals are sent between modules located in an aircraft equipment bay and modules located within an aircraft wing via electrically conductive wires or coaxial cables. Such electrical connections tend to be heavy and lossy compared to the optical connections used in this embodiment. Thus, the above described system advantageously tends to provide reduced weight and power requirements.

Also, in this embodiment, the high power amplifier 108 and low noise amplifier 114 associated with an antenna 112 is located close to that antenna 112 in the relevant wing bay 418. This tends to be in contrast to conventional systems in which the amplifiers are located with the low level transmit and receive signal processing functions, e.g., within an aircraft equipment bay. By locating the amplifier close to the antenna, the power requirements, and hence also the weight, of those amplifiers tends to be significantly reduced.

Although in this first embodiment, the first and second optical modules 104, 106 are coupled together via two separate optical fibres 122, 132 (one fibre providing a transmission channel, and the other fibre providing a receive channel), nevertheless, in other embodiments, the optical modules 104, 106 may be coupled together via a different number of optical links, for example, a single optical fibre that provides both transmit and receive channels.

What will now be described is a second embodiment of a signal transmitting/receiving system, hereinafter referred to as the “further system”, in which a single optical fibre that provides both transmit and receive channels for multiple antennas.

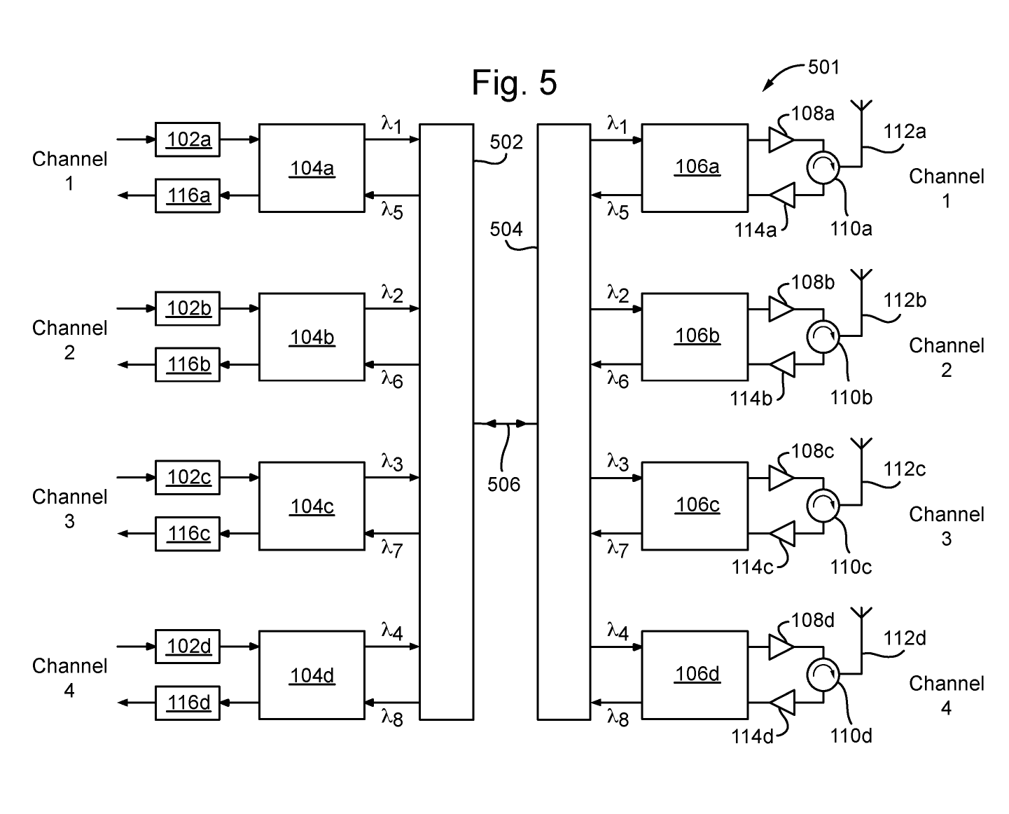

FIG. 5 is a schematic illustration (not to scale) of the further system 501. In this embodiment, the system 501 is implemented on-board the aircraft 400, as described in more detail later below. In the Figures, like reference numerals designate like parts.

The further system 501 comprises the modules and connections of four of the systems depicted in FIG. 1 and described above. The four systems 101 are coupled together as described in more detail later below to provide four transmit/receive channels.

In this embodiment, in addition to the modules and connections of four individual systems 101, the further system comprises a first wavelength division multiplexer/de-multiplexer 502 (hereinafter, the “first WDM”), a second wavelength division multiplexer/de-multiplexer 504 (hereinafter, the “second WDM”), and a bidirectional I optical fibre link 506. In this embodiment, a single optical fibre (i.e. the bidirectional optical fibre link 506) connects the first WDM 502 and the second WDM 504.

In FIG. 5, the reference numerals of the modules and connections associated with the first transmit/receive channel (CHANNEL 1) are supplemented with the reference symbol “a”. For example, the transmit signal processing module of the first channel is indicated by 102a, the first optical module of the first channel is indicated by 104a, and so on. Similarly, in FIG. 5, the reference numerals of the modules and connections associated with the second transmit/receive channel (CHANNEL 2) are supplemented with the reference symbol “b”. Similarly, in FIG. 5, the reference numerals of the modules and connections associated with the third transmit/receive channel (CHANNEL 3) are supplemented with the reference symbol “c”. Similarly, in FIG. 5, the reference numerals of the modules and connections associated with the fourth transmit/receive channel (CHANNEL 4) are supplemented with the reference symbol “d”.

In this embodiment, for the first channel, the transmit signal processing module 102a, the first optical module 104a, and the receive signal processing module 116a are coupled together and configured to operate as described in more detail earlier above with reference to FIGS. 1 to 3. The first optical module 104a of the first channel is as described in more detail earlier above with reference to FIG. 2. For a signal to be transmitted via the first channel, the first optical module 104a of the first channel is configured to produce an intensity modulated optical signal having a first wavelength λ₁. In other words, the laser in the first optical module 104a of the first channel generates a laser light signal having a first wavelength λ₁ which is modulated according to the RF signal output by the transmit signal processing module 102a. In operation, the first optical module 104a of the first channel sends the modulated optical signal having the first wavelength λ₁ to the first WDM 502 via an appropriate optical fibre.

In this embodiment, for the second channel, the transmit signal processing module 102b, the first optical module 104b, and the receive signal processing module 116b are coupled together and configured to operate as described in more earlier above with reference to FIGS. 1 to 3. The first optical module 104b of the second channel is as described in more detail earlier above with reference to FIG. 2. For a signal to be transmitted via the second channel, the first optical module 104b of the second channel is configured to produce an intensity modulated optical signal having a second wavelength λ₂. In other words, the laser in the first optical module 104b of the second channel generates a laser light signal having a second wavelength λ₂ which is modulated according to the RF signal output by the transmit signal processing module 102b. In operation, the first optical module 104b of the second channel sends the modulated optical signal having the second wavelength λ₂ to the first WDM 502 via an appropriate optical fibre.

In this embodiment, for the third channel, the transmit signal processing module 102c, the first optical module 104c, and the receive signal processing module 116c are coupled together and configured to operate as described in more earlier above with reference to FIGS. 1 to 3. The first optical module 104c of the third channel is as described in more detail earlier above with reference to FIG. 2. For a signal to be transmitted via the third channel, the first optical module 104c of the third channel is configured to produce an intensity modulated optical signal having a third wavelength λ₃. In other words, the laser in the first optical module 104c of the third channel generates a laser light signal having a third wavelength λ₃ which is modulated according to the RF signal output by the transmit signal processing module 102c. In operation, the first optical module 104c of the third channel sends the modulated optical signal having the third wavelength λ₃ to the first WDM 502 via an appropriate optical fibre.

In this embodiment, for the fourth channel, the transmit signal processing module 102d, the first optical module 104d, and the receive signal processing module 116d are coupled together and configured to operate as described in more earlier above with reference to FIGS. 1 to 3. The first optical module 104d of the fourth channel is as described in more detail earlier above with reference to FIG. 2. For a signal to be transmitted via the fourth channel, the first optical module 104d of the fourth channel is configured to produce an intensity modulated optical signal having a fourth wavelength λ₄. In other words, the laser in the first optical module 104d of the fourth channel generates a laser light signal having a fourth wavelength λ₄ which is modulated according to the RF signal output by the transmit signal processing module 102d. In operation, the first optical module 104d of the fourth channel sends the modulated optical signal having the fourth wavelength λ₄ to the first WDM 502 via an appropriate optical fibre.

Thus, in this second embodiment, in operation, the first WDM 502 receives modulated optical signals having wavelengths λ₁, λ₂, λ₃, and λ₄. The four modulated optical signals having wavelengths λ₁, λ₂, λ₃, and λ₄ correspond to the first channel, the second channel, the third channel, and the fourth channel respectively.

In this embodiment, the four wavelengths λ₁, λ₂, λ₃, and λ₄ are all different. This tends to provide that the four modulated optical signals may be distinguished from one another.

In this embodiment, the first WDM 502 is configured to multiplex four optical signals received from the first optical modules 104a, 104b, 104c, 104d. The four signals having wavelengths λ₁, λ₂, λ₃, and λ₄ are multiplexed by the first WDM 502 onto the bidirectional digital optical link 506, and sent from the first WDM 502 to the second WDM 504 via the bidirectional optical fibre link 506.

In this embodiment, the second WDM 504 is configured to de-multiplex the optical signal received from the first WDM 502 into four separate signals having wavelengths λ₁, λ₂, λ₃, and λ₄ respectively.

In operation, the second WDM 504 directs the modulated optical signal having the first wavelength λ₁ to the second optical module 106a of the first channel. The second optical module 106a of the first channel is as described in more detail earlier above with reference to FIG. 3. The second optical module 106a of the first channel is configured to convert the received optical signal to an electrical signal, which is subsequently transmitted by the antenna 112a of the first channel as described in more detail earlier above with reference to FIGS. 1 to 3.

Also, the second WDM 504 is configured to direct the modulated optical signal having the second wavelength λ₂ to the second optical module 106b of the second channel. The second optical module 106b of the second channel is as described in more detail earlier above with reference to FIG. 3. The second optical module 106b of the second channel is configured to convert the received optical signal to an electrical signal, which is subsequently transmitted by the antenna 112b of the second channel as described in more detail earlier above with reference to FIGS. 1 to 3.

Also, the second WDM 504 is configured to direct the modulated optical signal having the third wavelength λ₃ to the second optical module 106c of the third channel. The second optical module 106c of the third channel is as described in more detail earlier above with reference to FIG. 3. The second optical module 106c of the third channel is configured to convert the received optical signal to an electrical signal, which is subsequently transmitted by the antenna 112c of the third channel as described in more detail earlier above with reference to FIGS. 1 to 3.

Also, the second WDM 504 is configured to direct the modulated optical signal having the fourth wavelength λ₄ to the second optical module 106d of the fourth channel. The second optical module 106d of the fourth channel is as described in more detail earlier above with reference to FIG. 3. The second optical module 106d of the fourth channel is configured to convert the received optical signal to an electrical signal, which is subsequently transmitted by the antenna 112d of the fourth channel as described in more detail earlier above with reference to FIGS. 1 to 3.

In this embodiment, for the first channel, the second optical module 106a, the power amplifier 108a, the electrical circulator 110a, the antenna 112a, and the low-noise amplifier 114a are coupled together and configured to operate as described in more detail earlier above with reference to FIGS. 1 to 3. For a signal to be received via the first channel, the second optical module 106a of the first channel is configured to produce an intensity modulated optical signal having a fifth wavelength λ₅. In other words, the laser in the second optical module 106a of the first channel generates a laser light signal having a fifth wavelength λ₅ which is modulated according to the RF signal received by the antenna 112a and provided to the second optical module 106a by the low-noise amplifier 114a. In operation, the second optical module 106a of the first channel sends the modulated optical signal having the fifth wavelength λ₅ to the second WDM 504 via an appropriate optical fibre.

In this embodiment, for the second channel, the second optical module 106b, the power amplifier 108b, the electrical circulator 110b, the antenna 112b, and the low-noise amplifier 114b are coupled together and configured to operate as described in more detail earlier above with reference to FIGS. 1 to 3. For a signal to be received via the second channel, the second optical module 106b of the second channel is configured to produce an intensity modulated optical signal having a sixth wavelength λ₆. In other words, the laser in the second optical module 106b of the second channel generates a laser light signal having a sixth wavelength λ₆ which is modulated according to the RF signal received by the antenna 112b and provided to the second optical module 106b by the low-noise amplifier 114b. In operation, the second optical module 106b of the second channel sends the modulated optical signal having the sixth wavelength λ₆ to the second WDM 504 via an appropriate optical fibre.

In this embodiment, for the third channel, the second optical module 106c, the power amplifier 108c, the electrical circulator 110c, the antenna 112c, and the low-noise amplifier 114c are coupled together and configured to operate as described in more detail earlier above with reference to FIGS. 1 to 3. For a signal to be received via the third channel, the second optical module 106c of the third channel is configured to produce an intensity modulated optical signal having a seventh wavelength λ₇. In other words, the laser in the second optical module 106c of the third channel generates a laser light signal having a seventh wavelength λ₇ which is modulated according to the RF signal received by the antenna 112c and provided to the second optical module 106c by the low-noise amplifier 114c. In operation, the second optical module 106c of the third channel sends the modulated optical signal having the seventh wavelength λ₇ to the second WDM 504 via an appropriate optical fibre.

In this embodiment, for the fourth channel, the second optical module 106d, the power amplifier 108d, the electrical circulator 110d, the antenna 112d, and the low-noise amplifier 114d are coupled together and configured to operate as described in more detail earlier above with reference to FIGS. 1 to 3. For a signal to be received via the fourth channel, the second optical module 106d of the fourth channel is configured to produce an intensity modulated optical signal having a eighth wavelength λ₈. In other words, the laser in the second optical module 106d of the fourth channel generates a laser light signal having an eighth wavelength λ₈ which is modulated according to the RF signal received by the antenna 112d and provided to the second optical module 106d by the low-noise amplifier 114d. In operation, the second optical module 106d of the fourth channel sends the modulated optical signal having the eighth wavelength λ₈ to the second WDM 504 via an appropriate optical fibre.

Thus, in this second embodiment, in operation, the second WDM 504 receives modulated optical signals having wavelengths λ₅, λ₆, λ₇, and λ₈. The four modulated optical signals having wavelengths λ₅, λ₆, λ₇, and λ₈ correspond to the first channel, the second channel, the third channel, and the fourth channel respectively.

In this embodiment, the four wavelengths λ₅, λ₆, λ₇, and λ₈ are all different. This tends to provide that those four modulated optical signals may be distinguished from one another. In some embodiments, the wavelengths λ₁, λ₂, λ₃, λ₄, λ₅, λ₆, λ₇, and λ₈ are all different.

In this embodiment, the second WDM 504 is configured to multiplex the four optical signals received from the second optical modules 106a, 106b, 106c, 106d. The four signals having wavelengths λ₅, λ₆, λ₇, and λ₈ are multiplexed by the second WDM 504 onto the bidirectional optical fibre link 506, and sent from the second WDM 504 to the first WDM 502 via the bidirectional digital optical link 506.

In this embodiment, the first WDM 502 is configured to de-multiplex the optical signal received from the second WDM 504 into four separate signals having wavelengths λ₅, λ₆, λ₇, and λ₈ respectively.

In operation, the first WDM 502 directs the modulated optical signal having the fifth wavelength λ₅ to the first optical module 104a of the first channel. The first optical module 104a of the first channel is configured to convert the received optical signal to an electrical signal, which is subsequently transferred to and processed by the receive signal processing module 116a as described in more detail earlier above with reference to FIGS. 1 to 3.

Also, the first WDM 502 is configured to direct the modulated optical signal having the sixth wavelength λ₆ to the first optical module 104b of the second channel. The first optical module 104b of the second channel is configured to convert the received optical signal to an electrical signal, which is subsequently transferred to and processed by the receive signal processing module 116b as described in more detail earlier above with reference to FIGS. 1 to 3.

Also, the first WDM 502 is configured to direct the modulated optical signal having the seventh wavelength λ₇ to the first optical module 104c of the third channel. The first optical module 104c of the third channel is configured to convert the received optical signal to an electrical signal, which is subsequently transferred to and processed by the receive signal processing module 116c as described in more detail earlier above with reference to FIGS. 1 to 3.

Also, the first WDM 502 is configured to direct the modulated optical signal having the eighth wavelength λ₈ to the first optical module 104d of the fourth channel. The first optical module 104d of the fourth channel is configured to convert the received optical signal to an electrical signal, which is subsequently transferred to and processed by the receive signal processing module 116d as described in more detail earlier above with reference to FIGS. 1 to 3.

Thus the further system 501 in which a single optical fibre that provides both transmit and receive channels for multiple antennas is provided.

In this second embodiment, the further system 501 is implemented on-board the aircraft 400.

In this second embodiment, the antennas 112a-d provide “all-round” or spherical transmit/receive capability for the aircraft 400, for example, as follows: the first channel antenna 112a may be an upper left-hand wing antenna; the second channel antenna 112b may be a lower left-hand wing antenna; the third channel antenna 112c may be an upper right-hand wing antenna; and the fourth channel antenna 112d may be a lower right-hand wing antenna.

Also, the transmit signal processing modules 102a-d, the first optical modules 104a-d, and the receive signal processing modules 116a-d are wholly located within the equipment bay 416. For each channel, the transmit signal processing module, the first optical module, and the receive signal processing module are located proximate to one another so as to reduce the physical lengths of the electrical links between those modules.

Also, for each channel, the second optical module, the power amplifier, the electrical circulator, the antenna, and the low-noise amplifier of that channel are wholly located in a common wing bay 418. The wing bay 418 in which the second optical module, the power amplifier, the electrical circulator, the antenna, and the low-noise amplifier of a channel are located is the wing bay 418 that is at or proximate to the location of that antenna on the aircraft 400. For example, for the first channel, the antenna 112a is the upper left-hand wing antenna. Thus, the second optical module 106a, the power amplifier 108a, the electrical circulator 110a, the antenna 112a, and the low-noise amplifier 114a of the first channels are wholly located in a wing bay 418 within the left-hand wing of the aircraft 400 proximate to the left-hand wing tip 410 and the upper surface of the aircraft 400.

For a channel, the second optical module, the power amplifier, the electrical circulator, the antenna, and the low-noise amplifier are located proximate to one another such that the physical lengths of the electrical links which connect those modules are reduced.

In this second embodiment, for each channel, the transmit signal processing module, the first optical module, and the receive signal processing module are spatially separated, i.e. remote from, the second optical module, the power amplifier, the electrical circulator, the antenna, and the low-noise amplifier. For each channel, the modules of that channel that are located within the equipment bay 416 are coupled to the modules of that channel that are located within a common wing bay 418 at least in part by the bidirectional optical fibre link 506 (which, in this second embodiment corresponds to the a communication link 420).

Similarly to the first embodiment, in this second embodiment, modules that are physically separated by relatively large distances are coupled together by optical fibre communications links. Also, for each channel, the high power amplifier 108a-d and low noise amplifier 114a-d associated with an antenna 112a-d are located close to that antenna 112a-d in a relevant wing bay 418. This tends to be in contrast to conventional systems in which the amplifiers are located with the low level transmit and receive signal processing functions.

In the second embodiment, a signal from each of the transmit signal processing modules 102a-d is transmitted by a respective antenna 112a-d. Similarly, a signal received from each of the antennas 112a-d is processed by a respective receive signal processing modules 116a-d. What will now be described is a third embodiment of a signal transmitting/receiving system in which antennas for transmitting and/or receiving signals may be selected or switched.

In this third embodiment, the signal transmitting/receiving system is implemented on the aircraft 400.

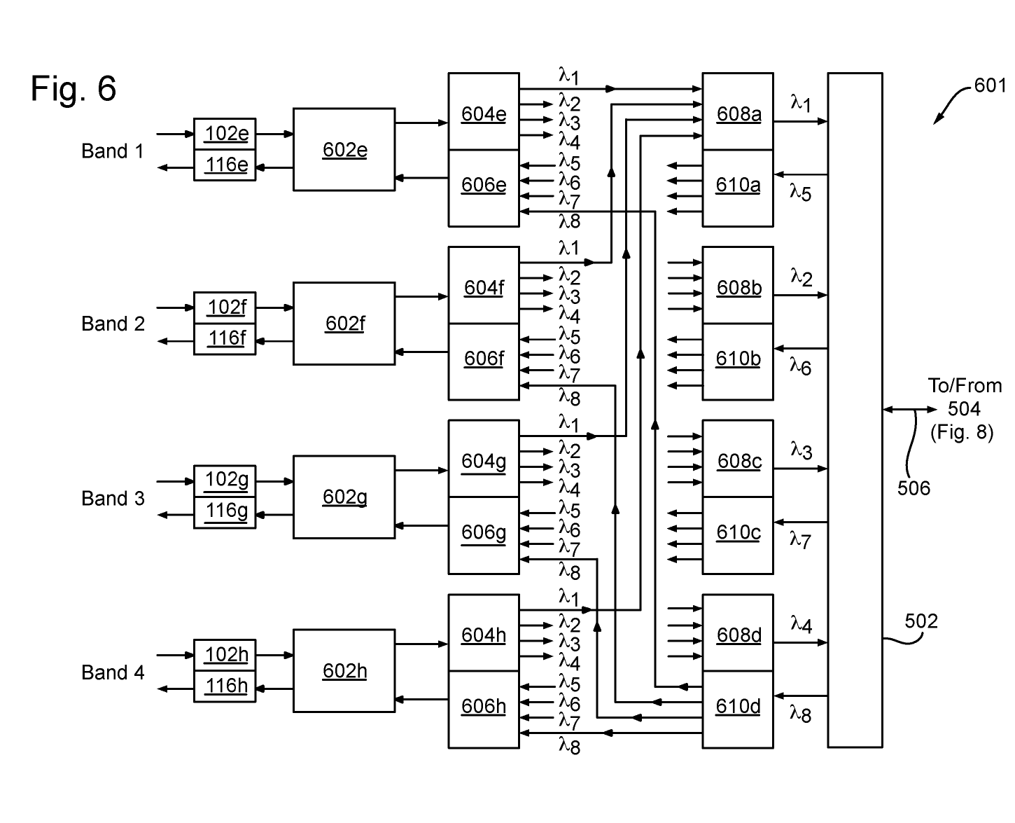

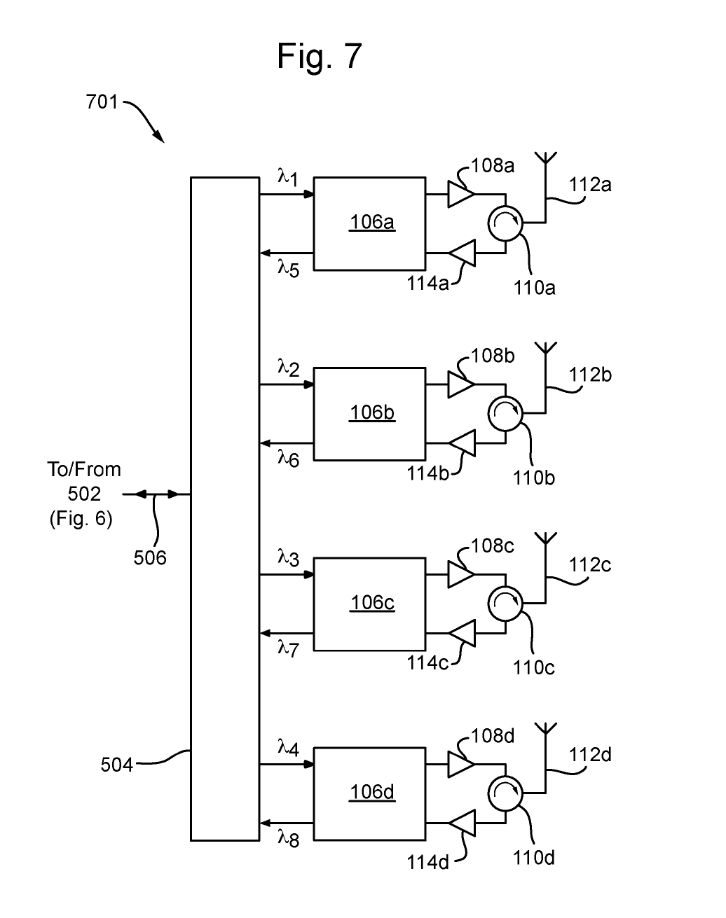

FIG. 6 is a schematic illustration (not to scale) showing modules and apparatus located at the equipment bay 416 in the third embodiment. The modules and apparatus shown in FIG. 6 are hereinafter collectively referred to as the “equipment bay modules” and indicated using the reference numeral 601.

FIG. 7 is a schematic illustration (not to scale) showing modules and apparatus located at the wing bays 418 in the third embodiment. The modules and apparatus shown in FIG. 7 are hereinafter collectively referred to as the “wing bay modules” and indicated using the reference numeral 701.

In this third embodiment, the wing bay modules 701 including the antennas 112a-d are configured to operate with RF signals within all of the four communication bands (BANDS 1-4). Thus, the wing bay modules 701 in this third embodiment may be wider bandwidth than those used in, for example, the second embodiment and described in more detail earlier above with reference to FIG. 5. The wider bandwidth of the wing bay modules 701 notwithstanding, operation of the wing bay modules 701 in this third embodiment is the same as in the second embodiment and described in more detail earlier above with reference to FIG. 5.

The first WDM 504 shown in FIG. 6 is connected, via the bidirectional digital optical link 506, to the second WDM 504 shown in FIG. 7.

In this embodiment, there are four communication bands, each having a different RF frequency range, namely a first band (BAND 1), a second band (BAND 2), a third band (BAND 3), and a fourth band (BAND 4). Each of the communication bands may be used to transmit a different respective type of data, for example, the first band may be used to transmit video data, the second band may be used to transmit telemetry data, the third band may be used to transmit audio data (e.g. voice communications), and the fourth band may be used to transmit mission data. Each of the communication bands may be used to transmit a signal having a different respective frequency, for example, the first band may be used to transmit signals having a frequency range of 0.5 GHz to 1 GHz, the second band may be used to transmit signals having a frequency range of 2 GHz to 3 GHz, the third band may be used to transmit signals having a frequency range of 3.5 GHz to 4 GHz, and the fourth band may be used to transmit signals having a frequency of 5 GHz to 6 GHz. In this embodiment, the frequency ranges of the four communication bands do not overlap to any extent.

In this embodiment, the equipment bay modules 601 comprise, for each communication band, a respective set of modules including a transmit signal processing module 102, a receive signal processing module 116, an optical wavelength selectable optical module 602, a transmit WDM 604, and a receive WDM 606. In FIG. 6, the reference numerals of the modules associated with the first communication band (BAND 1) are supplemented with the reference symbol “e”. Thus, the transmit signal processing module for the first communication band is indicated by 102e, the receive signal processing module for the first communication band is indicated by 116e, the optical wavelength selectable optical module for the first communication band is indicated by 602e, the transmit WDM for the first communication band is indicated by 604e, and the receive WDM for the first communication band is indicated by 606e. Similarly, in FIG. 6, the reference numerals of the modules associated with the second communication band (BAND 2) are supplemented with the reference symbol “f”. Similarly, in FIG. 6, the reference numerals of the modules associated with the third communication band (BAND 3) are supplemented with the reference symbol “g”. Similarly, in FIG. 6, the reference numerals of the modules associated with the fourth communication band (BAND 4) are supplemented with the reference symbol “h”.

In this embodiment, as described in more detail later below, each of the communication bands may be used to transmit and receive signal via any of the four antennas 112a-d. As in FIG. 5 and described in more detail earlier above, in FIGS. 6 and 7, modules associated with transmitting/receiving signal via the first channel antenna 112a are supplemented with the reference symbol “a”, modules associated with transmitting/receiving signal via the second channel antenna 112a are supplemented with the reference symbol “b”, modules associated with transmitting/receiving signal via the third channel antenna 112c are supplemented with the reference symbol “c”, and modules associated with transmitting/receiving signal via the fourth channel antenna 112d are supplemented with the reference symbol “d”.

In addition to including the transmit signal processing modules 102e-h, the receive signal processing modules 116e-h, the optical wavelength selectable optical modules 602e-h, the transmit WDMs 604e-h, and the receive WDMs 606e-h, the equipment bay modules 601 include, for each of the antennas 112a-d, a respective signal combiner 608 and a respective signal splitter 610. In other words, the equipment bay modules 601 include a signal combiner 608a and a signal splitter 610a associated with the first channel antenna 112a, a signal combiner 608b and a signal splitter 610b associated with the second channel antenna 112b, a signal combiner 608c and a signal splitter 610c associated with the third channel antenna 112c, and a signal combiner 608d and a signal splitter 610d associated with the fourth channel antenna 112d.

What will now be described is an example operation of transmitting and receiving signals by the equipment bay modules 601 and the wing bay modules 701. Although only the transmission and reception of the first communication band signals will be described, it will be appreciated by the skilled person that signals within the other communication bands may be transmitted/received in a similar fashion by the relevant modules mutatis mutandis.

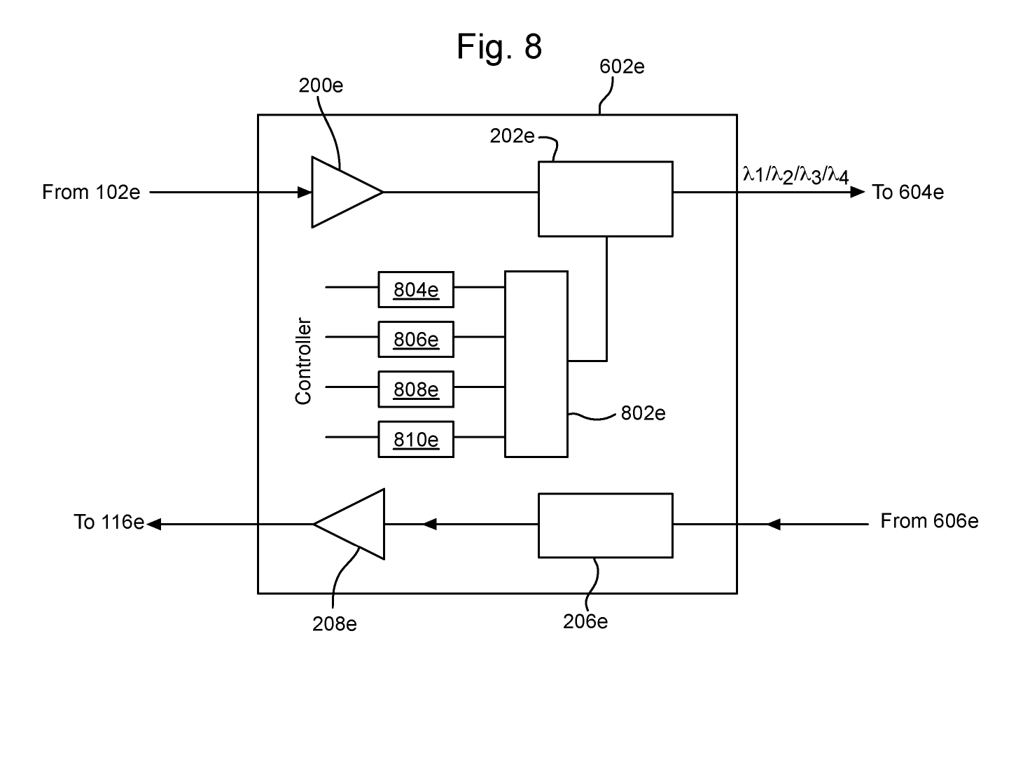

In the below description, reference is made to FIG. 8, which shows further details of the optical wavelength selectable optical module 602e associated with the first communication band. The other optical wavelength selectable optical modules 602f-h include modules and connections corresponding to those shown in FIG. 8 and described below.

In an example signal transmission operation, a digital or analogue base-band signal to be transmitted is input to the transmit signal processing module 102e associated with the first communication band. The transmit signal processing module 102e processes the signal and sends an RF signal to the optical wavelength selectable optical module 602e.

In this embodiment, as shown in FIG. 8, the optical wavelength selectable optical module 602e comprises a first RF amplifier 200e, a first optical modulator 202e, a first photodiode detector 206e, a first module low noise amplifier 208e, a module WDM 802e, and a plurality of lasers. The plurality of lasers includes a laser configured to generate laser light having the first wavelength λ₁ (which is hereinafter referred to as the “λ₁-laser” and is indicated by the reference numeral 804e), a laser configured to generate laser light having the second wavelength λ₂ (which is hereinafter referred to as the “λ₂-laser” and is indicated by the reference numeral 806e), a laser configured to generate laser light having the third wavelength λ₃ (which is hereinafter referred to as the “λ₃-laser” and is indicated by the reference numeral 808e), and a laser configured to generate laser light having the fourth wavelength λ₄ (which is hereinafter referred to as the “λ₄-laser” and is indicated by the reference numeral 810e).

In this embodiment, the lasers 804e, 806e, 808e, 810e are coupled to a controller. The controller may be external to the optical wavelength selectable optical module 602e, for example, a common controller may control the lasers 804e-h, 806e-h, 808e-h, 810e-h within all of the optical wavelength selectable optical modules 602e-h. The controller may be located within the equipment bay 416.

In the example transmission operation, the first RF amplifier 200e receives and amplifies the RF signal output by the transmit signal processing module 102e. The amplified RF signal is then sent from the first RF amplifier 200e to the first optical modulator 202e. As described above with reference to FIG. 2, the first optical modulator 202e is an integrated optical Mach Zehnder modulator.

In this embodiment, the controller determines from which of the four antennas 112a-d the signal is to be transmitted. If the signal is to be transmitted from the first channel antenna 112a, the controller controls the λ₁-laser 804e to send a laser signal (having the first wavelength λ₁) to the module WDM 802e. Similarly, if the signal is to be transmitted from the second channel antenna 112b, the controller controls the λ₂-laser 806e to send a laser signal (having the second wavelength λ₂) to the module WDM 802e. Similarly, if the signal is to be transmitted from the third channel antenna 112c, the controller controls the λ₃-laser 808e to send a laser signal (having the third wavelength λ₃) to the module WDM 802e. Similarly, if the signal is to be transmitted from the fourth channel antenna 112d, the controller controls the λ₄-laser 810e to send a laser signal (having the fourth wavelength λ₄) to the module WDM 802e. Thus, the module WDM 802e receives one or more laser signals from one or more of the lasers 804e, 806e, 808e, 810e depending upon which antenna(s) 112a-d the signal is to be transmitted from. The module WDM 802e multiplexes the received laser signals and send the multiplexed signal via a polarisation maintaining optical fibre to the first optical modulator 202e of the first communication band.

In this example signal transmitting operation, the first optical modulator 202e intensity modulates the multiplexed optical output received from the module WDM 802e using the amplified RF signal received from the first RF amplifier 200e. Thus, an intensity modulated optical signal is produced.

The first optical modulator 202e sends the output modulated optical signal to the transmit WDM 604e for the first communication band.

In this embodiment, the transmit WDM 604e is configured to de-multiplex the optical signal received from the first optical modulator 202e into four separate optical signals having wavelengths λ₁, λ₂, λ₃, and λ₄ respectively. In this embodiment, optical signals having the first wavelength λ₁ are for transmission via the first channel antenna 112a, optical signals having the second wavelength λ₂ are for transmission via the second channel antenna 112b, and so on.

In operation, after de-multiplexing the received optical signal, the transmit WDM 604e directs the modulated optical signal having the first wavelength λ₁ to the signal combiner 608a associated with the first channel antenna 112a. Also, the transmit WDM 604e directs the modulated optical signal having the second wavelength λ₂ to the signal combiner 608b associated with the second channel antenna 112b. Also, the transmit WDM 604e directs the modulated optical signal having the third wavelength λ₃ to the signal combiner 608c associated with the third channel antenna 112c. Also, the transmit WDM 604e directs the modulated optical signal having the fourth wavelength λ₄ to the signal combiner 608d associated with the fourth channel antenna 112d.

In this embodiment, the signal combiner 608a receives an optical signal having the first wavelength λ₁ from the transmit WDM 604e. The signal combiner 608a may also receive optical signals having the first wavelength λ₁ from one or more of the other transmit WDMs 604f-h if signals within the communication bands associated with those transmit WDMs 604f-h are to be transmitted by the antenna 112a. In this embodiment, the signal combiner 608a combines, into a single optical signal, the λ₁ wavelength signals received from all of the transmit WDMs 604e-h. The signal combiner 608a then sends the combined signal (which has a wavelength equal to λ₁) to the first WDM 502.

In this embodiment, a computer controlling the operation of the communication system manages the frequency and time access to the antennas so that simultaneous transmission of the four band signals is avoided. This tends to prevent interference between the four signals in the wing module components. Thus, for example, coherent optical mixing between the four λ₁ optical signals coincident at the photodiode detector 306s may be eliminated. Such management of the frequency and time access to the antennas may include, for example, for each antenna, allowing the RF signals of the four communications access to that antenna only at different times to one another. Also, in this embodiment, the frequencies of the RF signals of the four communication bands are sufficiently separated from one another so as to prevent interference between signals if more than one band signal if handled simultaneously.

The other signal combiners 608b-d combine the signals that they receive, and send those combined signals to the first WDM 502, in the same way as that described above for the signal combiner 608a associated with the first channel antenna 112a mutatis mutandis. For example, the signal combiner 608b corresponding to the second antenna 112b receives optical signals having the second wavelength λ₂ from one or more of the transmit WDMs 604e-h. These λ₂-signals are combined and sent to the first WDM 502 by the signal combiner 608b.

Thus, in this example signal transmitting operation, the first WDM 502 receives a combined optical signal having the first wavelength λ₁ from the signal combiner 608a, a combined optical signal having the second wavelength λ₂ from the signal combiner 608b, a combined optical signal having the third wavelength λ₃ from the signal combiner 608c, and a combined optical signal having the fourth wavelength λ₄ from the signal combiner 608d. The signals having wavelengths λ₁, λ₂, λ₃, and λ₄ are multiplexed by the first WDM 502 onto the bidirectional optical fibre link 506, and sent from the first WDM 502 to the second WDM 504 via the bidirectional optical fibre link 506.

In this example signal transmitting operation, the signals received by the second WDM 504 are processed by the wing bay modules 701 and transmitted by the antennas 112a-d as described in more detail earlier above in the second embodiment with reference to FIG. 5. For example, the second WDM 504 de-multiplexes the optical signal received from the first WDM 502 into four separate signals having wavelengths λ₁, λ₂, λ₃, and λ₄ respectively. The modulated optical signal having the first wavelength λ₁ is then directed to the second optical module 106a of the first channel which converts the received optical signal to electrical signal, which is subsequently transmitted by the antenna 112a. Signals may be transmitted by the other antennas 112b-d in the same way as for the antenna 112a mutatis mutandis. Thus, an example operation of transmitting signals by the equipment bay modules 601 and the wing bay modules 701 is provided.

In an example signal receiving operation performed by the equipment bay modules 601 and the wing bay modules 701, the wing bay modules 701 operate in the same way as in the second embodiment which is described in more detail earlier above with reference to FIG. 5. In particular, signals received at the antennas 112a-d are used to produce modulated optical signals having wavelengths λ₅, λ₆, λ₇, and λ₈ respectively. The four signals having wavelengths λ₅, λ₆, λ₇, and λ₈ are multiplexed by the second WDM 504 onto the bidirectional optical fibre link 506, and sent from the second WDM 504 to the first WDM 502 via the bidirectional optical fibre link 506.

In this embodiment, the first WDM 502 is configured to de-multiplex the optical signal received from the second WDM 504 into four separate signals having wavelengths λ₅, λ₆, λ₇, and λ₈ respectively.

In operation, after de-multiplexing the received optical signal, the first WDM 502 directs the modulated optical signal having the fifth wavelength λ₅ to the signal splitter 610a associated with the first antenna 112a. Also, the first WDM 502 directs the modulated optical signal having the sixth wavelength λ₆ to the signal splitter 610b associated with the second antenna 112b. Also, the first WDM 502 directs the modulated optical signal having the seventh wavelength λ₇ to the signal splitter 610c associated with the third antenna 112c. Also, the first WDM 502 directs the modulated optical signal having the eighth wavelength λ₈ to the signal splitter 610d associated with the fourth antenna 112d.

In this embodiment, the signal splitter 610a splits the optical signal having the fifth wavelength λ₅ to produce a separate optical signal for each of the communication bands. Thus in this embodiment, the signal splitter 610a splits the optical signal into four separate signals, each signal having the fifth wavelength λ₅. Each of the signals output by the signal splitter 610a is sent to a respective one of the receive WDMs 606e-h.

The other signal splitters 610b-d split the signals that they receive, and send an output signal to each of the receive WDMs 606e-h, in the same way as that described above for the signal splitter 610a associated with the first antenna 112a mutatis mutandis. For example, the signal splitter 610b corresponding to the second antenna 112b splits an optical signal having the sixth wavelength λ₆ into four separate signals and sends each of those signals to a respective one of the receive WDMs 606e-h.

In this embodiment, each of the receive WDMs 606e-h receives: from the signal splitter 610a, an optical signal having the fifth wavelength λ₅ corresponding to a signal received at the first antenna 112a; from the signal splitter 610b, an optical signal having the sixth wavelength λ₆ corresponding to a signal received at the second antenna 112b; from the signal splitter 610c, an optical signal having the seventh wavelength λ₇ corresponding to a signal received at the third antenna 112c; and, from the signal splitter 610d, an optical signal having the eighth wavelength λ₈ corresponding to a signal received at the fourth antenna 112d.

Each of the receive WDMs 606e-h multiplexes the four signals it receives and sends the resulting multiplexed optical signal to the optical wavelength selectable optical module 602e-h to which that receive WDM 606e-h is connected. For example, the receive WDM 606e of the first communication band sends its output multiplexed signal to the optical wavelength selectable optical module 602e of the first communication band.

The optical wavelength selectable optical modules 602e-h are each configured to convert the received optical signal to an electrical signal (via a respective photodiode detector 206 and low noise amplifier 208), which is subsequently transferred to and processed by a respective receive signal processing module 116e-h as described in more detail earlier above.

In some embodiments, one or more of the optical wavelength selectable optical modules 602e-h include a filter for filtering out signals having a particular wavelength that attempt to pass through that optical wavelength selectable optical module 602e-h. For example, in some embodiments, the receive signal processing module 116a corresponding to the first communication band is configured to only process signals received at the first channel antenna 112a. In such embodiments the optical wavelength selectable optical module 602e of the first band includes one or more filters for removing signals having the sixth, seventh, and eighth wavelengths λ₆, λ₇, λ₈ such that only optical signals having the fifth wavelength λ₅ (and hence corresponding to signals received at the first antenna 112a) are converted into electrical signals and passed to the receive signal processing module 116a for processing.

Thus, an example operation of receiving signals by the equipment bay modules 601 and the wing bay modules 701 is provided.

As mentioned above, in this third embodiment, the system is implemented on-board the aircraft 400. Also, the antennas 112a-d provide “all-round” or spherical transmit/receive capability for the aircraft 400.

In this third embodiment, the equipment bay modules 601 are located proximate to one another so as to reduce the physical lengths of the electrical links between those modules.

Also, for each channel, the wing bay modules 701 of that channel are located proximate to one another such that the physical lengths of the electrical links which connect those modules are reduced.

In this third embodiment, the equipment bay modules 601 are spatially separated, i.e. remote from, the wing bay modules 701. Similarly to the first and second embodiments, in this third embodiment, modules that are physically separated by relatively large distances are coupled together by optical fibre communications links. Also, for each antenna 112a-d, the high power amplifier 108a-d and low noise amplifier 114a-d associated with an antenna 112a-d are located advantageously close to that antenna 112a-d in a relevant wing bay 418.

Apparatus, including any of the above described signal processing or control means, for implementing any of the above arrangements, and performing any of the processes described above, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

It should be noted that certain of the processes described above may be omitted or such process steps may be performed in differing order to that presented above. Furthermore, although all the process steps have, for convenience and ease of understanding, been described as being discrete temporally-sequential steps, nevertheless some of the process steps may in fact be performed simultaneously or at least overlapping to some extent temporally.

It should also be noted that any of the aspects from an above described embodiment may be implemented in a different embodiment. For example, one or more modules selected from any of the above described systems may be implemented in a different above described system, for example, by replacing one or more modules from that different system, or in addition to the modules of that different system.

In the above embodiments, the modules of the systems are coupled together as described above. However, in other embodiments, the modules of one or more of the systems may be coupled together in a different appropriate way.

In the above embodiments, the signals being transferred between the equipment bay and the wing bays are RF signals that are to be transmitted by an antenna, or RF signals that have been received by an antenna. However, in other embodiments, the signals being transferred between the equipment bay and the wing bays have frequencies other than RF Bands 1, 2, 3 and 4. Also, in other embodiments, the signals being transferred between the equipment bay and the wing bays are signals that are not to be transmitted by an antenna or that have been received by an antenna, for example, a control signal for controlling apparatus.

In the above embodiments, the systems are implemented on-board a UAV. However, in other embodiments, a system is implemented on a different entity. For example, a system may be implemented on-board a manned aircraft a different type of vehicle such as a land-based or water-based vehicle, or a building or other structure. In some embodiments, a system is implement in or on an entity of a given size whose size and shape are determined so as to fulfil certain other criteria, for example, so as to provide the capability of flight.

In the above described second and third embodiments, there are four communication channels, each having a respective antenna. Also, the antennas are arranged on-board the aircraft so as to provide a spherical communication capability. However, in other embodiments, there is a different number of communication channels. In other embodiments, there is a different number of antennas. In other embodiments, the antennas are arranged on the aircraft in a different appropriate way, for example, not necessarily to provide a spherical communication capability.

In the above described third embodiment, there are four communication bands, each of which may correspond to a different data type. However, in other embodiments, there may be a different number of communication bands.

In the above embodiments, modules of a system are located either within an equipment bay of the aircraft or within a wing bay of the aircraft. However, in other embodiments, the modules of a system may be distributed across a different pair of spatially separate locations on-board the aircraft. Also, in other embodiments, the modules of a system may be distributed across more than two spatially separate locations on-board the aircraft, for example, the equipment bay, a wing bay, and a cockpit.

Also, one or more of the modules or pieces of equipment that is described above as being located within the equipment bay may, in other embodiments, instead be located at a wing bay and vice versa. For example, in the above embodiments, the second laser 304 of a second optical module 106 is located within a wing bay 418. However, in other embodiments, the second laser 304 of a second optical module 106 is located within the equipment bay 416.

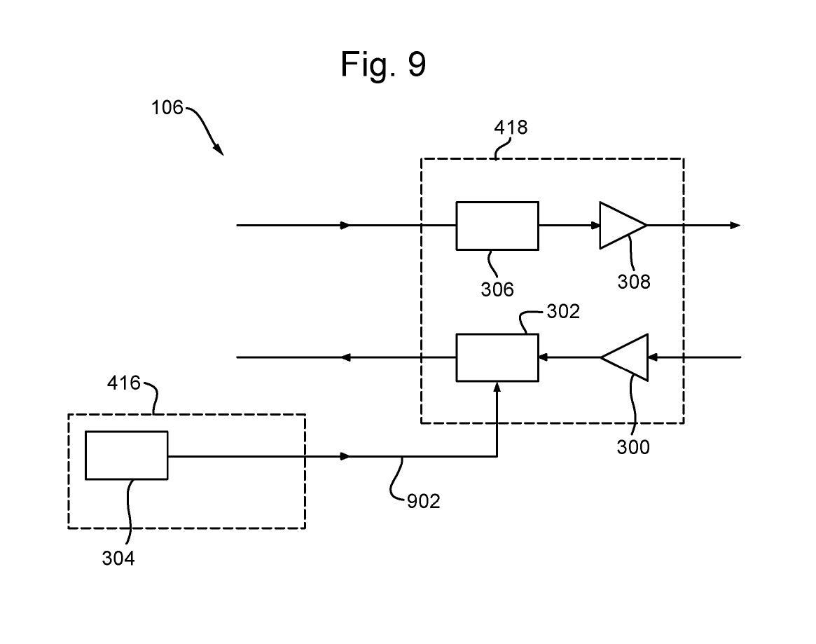

FIG. 9 is a schematic illustration (not to scale) showing a second optical module 106 having its laser 304 located at the equipment bay 416 as opposed to the wing bay 418.

In this embodiment the second RF amplifier 300, the second optical modulator 302, the second photodiode detector 306, and the second module low noise amplifier 308 of the second optical module 106 are located at the wing bay 418 and are coupled together and operate as described above with reference to FIG. 3. In this embodiment, the second laser 304 of the second optical module 106 is located at the equipment bay 416. This advantageously tends to provide that the second laser operates in a more stable thermal and mechanical environment. The second laser 304 is configured to send a laser signal to the second optical modulator 302 for modulation by the second optical modulator 302 via a polarisation maintaining optical fibre 902.

In this embodiment, the polarisation maintaining optical fibre 902 is a separate, dedicated optical fibre that is different to any of the other optical fibres (e.g. the first optical fibre 122, the second optical fibre 132, the bidirectional optical fibre link 506 etc.). However, in other embodiments, the laser signal sent from the second laser 304 located in the equipment bay 416 may be multiplexed with one or more other optical signals and sent from the equipment bay 416 to the second optical modulator 302 located within a wing bay 418 via a common polarisation maintaining optical fibre.

For example, in some embodiments, the laser signal sent from the second laser 304 located in the equipment bay 416 (which may, for example, have a wavelength of λ₅, λ₆, λ₇, or λ₈) may be multiplexed with one or more transmit signals (each of which may, for example, have a wavelength of λ₁, λ₂, λ₃, or λ₄) via a common polarisation maintaining optical fibre.

Also, in some embodiments, the second lasers 304a-d of each of the second optical modules 106a-d are all be located at the equipment bay 416. The laser signals produced by these second lasers 304a-d may be multiplexed together by an appropriate polarisation maintaining WDM and sent via a common polarisation maintaining optical fibre to the wing bays 418 where the multiplexed signal may be de-multiplexed by a further polarisation maintaining WDM into respective laser signals for each of the second optical modulators 302a-d.

What is claimed is:

1. A signal processing apparatus located in and/or mounted on an entity, the signal processing apparatus comprising:
a first module;
a second module operatively connected to the first module such that a signal may be sent between the first module and the second module;
one or more amplifiers operatively connected to the first and second modules such that a signal sent between the first module and the second module is amplified by the one or more amplifiers; and
one or more optical fibre communication links; wherein
the first module is located at a first location in or on the entity;
the second module and the one or more amplifiers are located at a second location in or on the entity;
the first location and the second location are spatially separate such that the first module is remote from the second module and the one or more amplifiers; and
the one or more optical fibre communication links couple together the first location and the second location such that a signal sent between the first location and the second location is sent via the one or more optical fibre communications links.

2. A signal processing apparatus according to claim 1, wherein:
the first module comprises a signal processor configured to output a signal for use by the second module; and
the apparatus further comprises a first optical modulator located at the first location and operatively coupled to the signal processor and configured to produce a modulated optical signal corresponding to the signal output by the signal processor, the first optical modulator being further operatively coupled to the one or more optical communication links such that the modulated optical signal produced by the first optical modulator is sent to the second location via the one or more optical communication links.

3. A signal processing apparatus according to claim 2, wherein:
the apparatus further comprises a first optical-electrical converter located at the second location and configured to convert the optical signal received from the first location to an electrical signal; and
the second module comprises an antenna configured to transmit, for use by a further entity remote from the entity, the electrical signal produced by the first optical-electrical converter.

4. A signal processing apparatus according to claim 3, wherein the one or more amplifiers includes a power amplifier configured to amplify the electrical signal output by the first optical-electrical converter and provide the amplified signal to the antenna.

5. A signal processing apparatus according to claim 1, wherein:
the second module comprises an antenna configured to receive, from a further entity remote from the entity, a signal; and
the apparatus further comprises a second optical modulator located at the second location and operatively coupled to the antenna and configured to produce a modulated optical signal corresponding to the signal received by the antenna, the second optical modulator being further operatively coupled to the one or more optical communication links such that the modulated optical signal produced by the second optical modulator is sent to the first location via the one or more optical communication links.

6. A signal processing apparatus according to claim 5, wherein:
the apparatus further comprises a second optical-electrical converter located at the first location and configured to convert the optical signal received from the second location to an electrical signal; and
the first module comprises a signal processor configured to process the electrical signal output by the second optical-electrical converter.

7. A signal processing apparatus according to claim 5, wherein the one or more amplifiers includes a low noise amplifier configured to amplify the signal received by the antenna and provide the amplified signal to the second optical modulator.

8. A signal processing apparatus according to claim 5, wherein:
the apparatus further comprises a laser;
the laser is operatively coupled to the second optical modulator via a polarization maintaining optical fibre communications link;
the laser is configured to produce an optical input to the second optical modulator for modulation by the second optical modulator; and
the laser is located at the first location.

9. A signal processing apparatus according to claim 1, wherein the apparatus further comprises:
a further first module;
a further second module operatively connected to the further first module such that a signal may be sent between the further first module and the further second module;
one or more further amplifiers operatively connected to the further first and further second modules such that a signal sent between the further first module and the further second module is amplified by the one or more amplifiers; and
a multiplexer configured to multiplex the signal being sent between the first module and the second module and the signal being sent between the further first module and the further second module onto a common optical fibre communication link.

10. A signal processing apparatus according to claim 1, wherein the apparatus further comprises a de-multiplexer configured to de-multiplex the multiplexed signal produced by the multiplexer into the signal being sent between the first module and the second module and the signal being sent between the further first module and the further second module, the multiplexer and the de-multiplexer being located at different respective locations selected from the group of locations consisting of the first location and the second location.

11. A signal processing apparatus according to claim 1, wherein the apparatus further comprises:
at least one further second module operatively connected to the first module such that a signal may be sent between the first module and each of the further second modules;
an optical modulator located at the first location and operatively coupled to the first module and configured to modulate an optical input so as to produce a modulated optical signal corresponding to a signal output by the first module;
a controller configured to select a wavelength (λ1, λ2, λ3, λ4) from a set of multiple different wavelengths for the optical input to the optical modulator;
one or more lasers configured to produce the optical input to the optical modulator having the selected wavelength (λ1, λ2, λ3, λ4); and
means for directing optical signals having different wavelengths to a different respective second module.

12. A signal processing apparatus according to claim 1, wherein the apparatus further comprises:
at least one further second module operatively connected to the first module such that a signal may be sent between the first module and each of the further second modules;
for each second module, a respective optical modulator operatively coupled to that second module and configured to produce a modulated optical signal, the optical modulators being configured to each produce a modulated optical signal having a different respective wavelength (λ5, λ6, λ7, λ8); and
for at least one of the wavelengths (λ5, λ6, λ7, λ8) of the signals produced by the optical modulators, a filter for preventing a signal having that wavelength being received by the first module.

13. A signal processing apparatus according to claim 1, wherein the entity is an aircraft.

14. A signal processing apparatus according to claim 13, wherein the second location is in or on a wing of the aircraft, and the first location is remote from that wing of the aircraft.

15. An aircraft comprising a signal processing apparatus according to claim 1.
